(19) United States
(12) Patent Application Publication
(10) Pub. No.: US 2025/0341670 A1
(43) Pub. Date: Nov. 6, 2025

(54) OPTICAL WAVEGUIDE WITH A LAYER FOR REDUCING REFLECTION AND RETARDANCE

(71) Applicant: Carl Zeiss Jena GmbH, Jena (DE)

(72) Inventors: Michael TOTZECK, Schwaebisch Gmuend (DE); Diana TONOVA, Aalen (DE)

(21) Appl. No.: 18/870,599

(22) PCT Filed: May 16, 2016
(86) PCT No.: PCT/EP2023/063194

§ 371 Date: Nov. 29, 2024

(30) Foreign Application Priority Data
May 30, 2022 (DE) 10 2022 113 551.9

(51) Int. Cl. F21V 8/00; G02B 1/118

(52) U.S. Cl. CPC G02B 6/0043; G02B 1/118; G02B 6/0018

(57) ABSTRACT

An optical waveguide for arranging in the beam path of an optical assembly includes a substrate with at least two opposing boundary surfaces for guiding optical waves via total internal reflection. The at least two boundary surfaces each have an outer layer with a refractive index progression whereby, starting from the respective boundary surface, the effective refractive index of the outer layer reduces over a determined course outwards at an increasing distance from the boundary surface.

### PRIORITY

This application claims the benefit of German Patent Application No. 10 2022 113 551.9 filed on May 30, 2022, which is hereby incorporated herein by reference in its entirety.

### FIELD

The present invention relates to an optical waveguide for arranging in the beam path of an optical arrangement, for example of augmented reality glasses (AR glasses). The invention additionally relates to an optical arrangement, an image reproduction apparatus and an image capture apparatus.

### BACKGROUND

Generally, in the case of a head-mounted display, the image created by a picture-generating unit or a display is input coupled into an optical waveguide, reflected one or more times within the optical waveguide by means of total internal reflection and finally output coupled such that a user of the head-mounted display can see a virtual image. The region in space from where the virtual image is visually perceivable by a user is also referred to as an eyebox.

When a user looks through “augmented reality glasses”, or “AR glasses” for short, they see a superimposed “virtual image” overlaid on their image of the physical world (“real image”). This overlay is achieved by way of a beam combiner which, on the one hand, is transparent to ambient light but, on the other hand, also steers a pencil of rays or beam created by an external picture generator to the eye or into an eyebox. The eye perceives this beam as a virtual image.

One common form of beam combiner is that of a light guide plate (“waveguide”). That is a plane-parallel plate composed of a material having a high refractive index n₁, in which plate the beams of the virtual image are guided by total internal reflection. The material surrounding the plate has a lower refractive index no. Light with an angle α of incidence of between 90° and the critical angle α_{gr} of total internal reflection

$${α}_{gr} = arc sin \frac{{n}_{1}}{{n}_{0}}$$

is guided in the plate by total internal reflection. FIG. 1 illustrates this.

The output coupling in the direction of the eyebox or a user's eye can take place in various ways. In this respect, the document U.S. Pat. No. 7,724,442 B2 discloses oblique mirror layers incorporated into the plate, the document US 2017/0059759 A1 discloses holograms situated within the light guide plate, and the document US 2016/0033784 A1 discloses surface gratings. The document US 2020/0142196 A1 describes input coupling and output coupling elements in regard to an optical waveguide, which elements can comprise GRIN material (GRIN-gradient refractive index), i.e. material whose refractive index has a gradient. The document EP 2 376 071 B1 discloses a waveguide having a coating that reduces the critical angle of total internal reflection.

Irrespective of the input and output coupling method, the light guide plate must fulfil two core tasks simultaneously, namely (1) permitting an undisturbed, bright image of the surroundings and (2) providing a realistic virtual image. Condition (2) requires the image brightness within the field of view (FoV) and for each position in the eyebox not to be undesirably dependent on the viewing direction or the position of the pupil of the eye in the eyebox. An eyebox is understood to mean that region in the beam path downstream of the beam combiner from which the virtual image is visible. FIG. 2 illustrates this requirement. The maximum occurring intensity variation A/must therefore be small.

While requirement (1) can be satisfied by a suitable coating (antireflection coating-ARC), the use of which is standard practice in optics, requirement (2) is more difficult to satisfy. That is owing to the fact that the total internal reflection above the critical angle does have, but the output coupling does not have, a reflectance of 1 independently of the wavelength, the angle of incidence and the polarization of the light. The output coupling is dependent on all three parameters for all the output coupling principles mentioned. Variations of these parameters lead to undesired brightness variations in the image.

In order nevertheless to satisfy the requirements mentioned, there are the following countermeasures, for example, in the prior art: The wavelength dependence is manifested to a lesser extent if the illumination is spectrally narrowband. That can be achieved in particular by three narrow spectral ranges in R, G, B (R—red light, G—green light, B—blue light) being used for the illumination and each of the three ranges being given a dedicated beam combiner (“stacking of beam combiners”), as described in US 2017/0212348 A1, for example. The angle dependence of the output coupling is taken into account by the design of the output coupling elements, for example by the use of multiplex holograms or angularly broadband coatings. In contrast, the polarization dependence is difficult to manage because reflective output coupling elements operate close to the Brewster angle and diffractive structures, for example holographic structures, have small periods, which as is known likewise have a polarization-dependent diffraction efficiency.

The polarization dependence of the output coupling is not in itself problematic, however, but rather is problematic only if the polarization state of the guided light changes during propagation. However, that is already the case for partly polarized light which propagates by total internal reflection in the optical waveguide. The reason for this effect is the “phase shift during total internal reflection”, as is described in the customary textbooks, for example “Principles of Optics” by Max Born and Emil Wolf, and represented mathematically by the Fresnel equations. As a result, the total internal reflection causes the same effect as a small birefringent retardation plate, namely a relative phase shift of the two eigenpolarizations, here referred to as “retardance”. The prior art makes use of the effect in the form of the “Fresnel rhomb” for producing half- and quarter-wave retardation elements (“retarders”).

In R. M. A. Azzam, “Phase shifts that accompany total internal reflection at a dielectric-dielectric interface”, J. Opt. Soc. Am. A 21, 1559-1563 (2004), an analytical expression is derived for the retardation Δ as a function of the angle Φ of incidence and the refractive index quotient N=n₁/n₀ (where n₁ is the refractive index of the light guide plate and no is the refractive index of the surrounding medium):

$$tan ( \frac{Δ}{2} ) = \frac{\sqrt{{N}^{2} {sin}^{2} ϕ - 1}}{N sin ϕ tan ϕ}$$

As shown in FIG. 3, for the angular range of beam propagation of from 50 degrees to 90 degrees, this range being relevant to the antireflective effect, for a plate index of n₁=1.7 and a surroundings index of n₀=1.0, retardations of up to 58 degrees arise. This value is very high since a retardance of 90 degrees can already convert linearly polarized light into circularly polarized light and a retardance of 180° can convert a polarization state into its orthogonal polarization state, i.e. for example left into right circularly polarized light or linear x-polarization into linear y-polarization.

At the same time, in a see-through view, a high transmission must be ensured, i.e. the boundary surface between the light guide plate and the surroundings should be made antireflective.

It has been found that a polarization-neutral total internal reflection with at the same time an antireflective effect for perpendicular passage in order that a user can see the virtual image and the real image equally well cannot be ensured by a simple homogeneous vapor-deposited antireflection layer. As is shown in Z. P. Wang, W. M. Sun, S. L. Ruan, C. Kang, Z. J. Huang, und S. Q. Zhang, “Polarization-preserving totally reflecting prisms with a single medium layer”, Appl. Opt. 36, 2802-2806 (1997), a polarization neutrality requires a layer thickness of half a wavelength, which in transmission corresponds to a reflective effect and not an antireflective effect. The use of material having a high refractive index (high index material) in the layer stack in order to improve the antireflection effect makes the retardance even greater, which will be shown further below with reference to FIGS. 4 to 9.

### SUMMARY

An object herein is to provide an advantageous optical waveguide for arranging in the beam path of an optical arrangement, an optical arrangement, an image reproduction apparatus and an image capture apparatus.

The optical waveguide is designed for arranging in the beam path of an optical arrangement and comprises a substrate, for example in the form of a component, in particular a plane-parallel plate, having at least two mutually opposite boundary surfaces, for example in the form of mutually opposite surface regions, for guiding light waves by means of total internal reflection. The at least two boundary surfaces each have an outer layer. The outer layer has a refractive index progression in which, proceeding from the respective boundary surface, the refractive index, in particular the effective refractive index, of the outer layer decreases over a defined course outward with increasing distance from the boundary surface.

The beam path is preferably a beam path for providing a virtual, in particular multicolored, image representation, e.g. the beam path of an image capture or image reproduction apparatus, in which a superimposed virtual, preferably multicolored, image or image representation is able to be overlaid on an image of the physical world (real image), this overlay being achieved by a beam combiner, e.g. a volume hologram. The beam path can thus be designed for overlaying a superimposed virtual image together with an image of the physical world by means of a beam combiner. In other words, it is thus intended to make possible both a see-through view through the optical waveguide and input coupling of a superimposed virtual image.

A decrease in the refractive index, in particular a continuous transition of the refractive index of the substrate to the value of the surroundings over a defined course, with increasing distance from the boundary surface leads to a broadband antireflective effect and significantly reduces the retardance of the guided field. A polarization-neutral total internal reflection in the optical waveguide with at the same time an antireflective effect for perpendicular passage is thus ensured. This has the advantage that a user can see the virtual image and the real image equally well. An optical waveguide is thus realized which is designed simultaneously for a see-through view and for an antireflective effect in respect of a virtual image.

The optical waveguide can be configured as a plate, in particular a plane-parallel plate. The boundary surfaces can be mutually opposite surfaces of the plate, for example a front side and a rear side. The optical waveguide can comprise a device for output coupling and/or input coupling of an imaging beam path. The device for output coupling and/or input coupling of an imaging beam path can be embodied in the form of a volume hologram.

The outer layer can be embodied as a nanostructured surface region and/or as a coating. In the case of a nanostructuring, the surface region forming the outer layer can have depressions in the surface having a depth of at least 300 nanometers, preferably at least 800 nanometers, and/or a distance from one another, e.g. a lateral distance, of a maximum of 100 nanometers, for example a maximum of 50 nanometers, preferably a maximum of 10 nanometers. In this case, it is advantageous if the depth of the depressions corresponds to at least a wavelength, preferably double the wavelength, particularly preferably more than triple the wavelength, of the light guided in the optical waveguide. The depressions can be configured in pyramidal or conical fashion, for example. The depressions are preferably filled with air or a material having a refractive index which is lower than that of the substrate. As a result, the effective refractive index of the outer layer has a gradient and, proceeding from the respective boundary surface, decreases outward with increasing distance from the boundary surface.

In one advantageous variant, proceeding from the respective boundary surface, the refractive index of the outer layer, for example of a coating, decreases outward at least partly in a continuous manner, for example in accordance with a continuous function. In a further variant, proceeding from the respective boundary surface, the refractive index of the outer layer, for example of a coating, decreases outward at least partly in a stepped manner, for example in accordance with a step function.

Preferably, proceeding from the respective boundary surface, the refractive index of the outer layer decreases outward at least partly in accordance with a function, for example in accordance with a monotonic and/or continuous function, of the distance from the respective boundary surface. A decrease in the refractive index in accordance with a monotonic function means here that the value of the refractive index falls or remains constant with increasing distance from the boundary surface. In particular, proceeding from the respective boundary surface, the refractive index of the outer layer can decrease with increasing distance from the boundary surface at least partly in accordance with a linear or quadratic function of the distance from the respective boundary surface.

In a further variant, the outer layer can comprise a coating having a layer thickness of at least 0.7 micrometer, preferably 1 micrometer. In particular, the outer layer can have a coating, the refractive index of the coating decreasing by at least 0.4, for example decreasing by at least 0.5, advantageously by at least 0.7, over a layer thickness of at least 0.7 micrometer and/or a layer thickness of at least 1.3 micrometers.

In one cost-effectively implementable variant, the outer layer can comprise a coating comprising a plurality of, i.e. at least two, layer plies which are arranged one on top of another and the refractive indices of which differ from one another. In this case, layer plies at a smaller distance from the respective boundary surface of the substrate designed for guiding light waves have a higher refractive index than layer plies at a larger distance from the respective boundary surface. The production engineering advantage of this variant is that individual layer plies each having a constant refractive index can be arranged one on top of another and GRIN material is therefore not required.

The outer layer can comprise a coating containing aluminum oxide (Al2O3) and/or silicon oxide (SiO2) and/or magnesium fluoride (MgF2). In association with the above-described variant, individual layer plies can consist of the materials mentioned. The outer layer can also comprise other materials having a refractive index which is between that of the optical waveguide and that of the surroundings.

All the variants and configuration examples described have the advantage that they promote guiding of the light waves in the optical waveguide without or at least with significantly reduced retardance, i.e. polarization-neutral light guiding, and at the same time offer an efficient antireflective effect for transmitted light, i.e. light which penetrates through the at least two mutually opposite boundary surfaces of the optical waveguide.

The optical arrangement according to certain example embodiments comprises the above-described optical waveguide and at least one device for output coupling and/or input coupling of an imaging beam path, preferably a beam path of a multicolored image representation or a multicolored image, into the optical waveguide. If the device for output coupling and/or input coupling of an imaging beam path is already integrated in the optical waveguide, such an optical waveguide simultaneously constitutes an optical arrangement. The optical arrangement has the features and advantages that have already been mentioned in connection with the optical waveguide.

The image reproduction apparatus according to certain example embodiments comprises an optical arrangement. It has the features and advantages that have already been mentioned in connection with the optical waveguide. The image reproduction apparatus can be configured for example as a head-mounted display (HMD), in particular AR glasses (AR—augmented reality), a head-up display (HUD) or a near-to-eye display. Further examples are smartglasses or AR headsets or VR headsets (VR—virtual reality) or MR headsets (MR—mixed reality) or VR or MR glasses or VR or MR helmets.

The image capture apparatus according to certain example embodiments comprises an optical arrangement. It has the features and advantages that have already been mentioned in connection with the optical waveguide. The image capture apparatus can be configured for example as an imaging arrangement or imaging apparatus, such as in particular smartglasses with gesture recognition or eye tracking, for example.

The invention is explained in greater detail below on the basis of exemplary embodiments with reference to the accompanying figures. Although the invention is more specifically illustrated and described in detail by means of the preferred exemplary embodiments, nevertheless the invention is not restricted by the examples disclosed and other variations can be derived therefrom by a person skilled in the art, without departing from the scope of protection of the invention.

The figures are not necessarily accurate in every detail and to scale, and can be presented in enlarged or reduced form for the purpose of better clarity. For this reason, functional details disclosed here should not be understood to be limiting, but merely to be an illustrative basis that gives guidance to a person skilled in this technical field for using the present invention in various ways.

The expression “and/or” used here, when it is used in a series of two or more elements, means that any of the elements listed can be used alone, or any combination of two or more of the elements listed can be used. For example, if a structure is described as containing the components A, B and/or C, the structure can contain A alone; B alone; C alone; A and B in combination; A and C in combination; B and C in combination; or A, B, and C in combination.

### BRIEF DESCRIPTION OF THE DRAWINGS

FIG. 1 schematically shows the propagation of a light beam in a light guide plate by total internal reflection.

FIG. 2 schematically shows the output coupling of light beams from an optical waveguide and the light intensity as a function of the output coupling angle.

FIG. 3 shows the retardance as a function of the angle of incidence of a light beam.

FIG. 4 shows a first antireflection or antireflective coating having layer plies having refractive indices of between 1.7 and 1.3.

FIG. 5 shows the retardance of the coating shown in FIG. 4 as a function of the angle of incidence of a light beam.

FIG. 6 shows a second antireflection or antireflective coating having layer plies having refractive indices of between 1.7 and 1.3.

FIG. 7 shows the retardance of the coating shown in FIG. 6 as a function of the angle of incidence of a light beam.

FIG. 8 shows a third antireflection or antireflective coating having layer plies having refractive indices of between 1.7 and 1.3.

FIG. 9 shows the retardance of the coating shown in FIG. 8 as a function of the angle of incidence of a light beam.

FIG. 10 shows a step transition from an optical waveguide having a refractive index of 1.7 to surroundings having a refractive index of 1.0 in the form of a diagram.

FIG. 11 shows the retardance of the optical waveguide shown in FIG. 10 as a function of the angle of incidence of a light beam.

FIG. 12 shows the refractive index progression of a first exemplary embodiment of an optical waveguide according to certain embodiments of the invention in the form of a diagram.

FIG. 13 shows the retardance of the optical waveguide shown in FIG. 12 as a function of the angle of incidence of a light beam having a wavelength of 500 nm.

FIG. 14 shows the retardance—averaged over all wavelengths from 400 nm to 700 nm—of the optical waveguide shown in FIG. 12 as a function of the angle of incidence of a light beam.

FIG. 15 shows a step transition from an optical waveguide having a refractive index of 1.7 to a coating material having a refractive index of 1.3 in the form of a diagram.

FIG. 16 shows the retardance of the optical waveguide shown in FIG. 15 as a function of the angle of incidence of a light beam.

FIG. 17 shows the refractive index progression of a second exemplary embodiment of an optical waveguide according to certain embodiments of the invention in the form of a diagram.

FIG. 18 shows the retardance of the optical waveguide shown in FIG. 17 as a function of the angle of incidence of a light beam.

FIG. 19 shows the reflectivity of the optical waveguide shown in FIG. 15 as a function of the angle of incidence of the light.

FIG. 20 shows the reflectivity of the optical waveguide shown in FIG. 17 as a function of the angle of incidence of the light.

FIG. 21 shows the refractive index progression of a third exemplary embodiment of an optical waveguide according to certain embodiments of the invention in the form of a diagram.

FIG. 22 shows the retardance of the optical waveguide shown in FIG. 21 as a function of the angle of incidence of a light beam.

FIG. 23 shows the reflectivity of the optical waveguide shown in FIG. 21 as a function of the angle of incidence of the light.

FIG. 24 shows the refractive index progression of a fourth exemplary embodiment of an optical waveguide according to certain embodiments of the invention in the form of a diagram.

FIG. 25 shows the retardance of the optical waveguide shown in FIG. 24 as a function of the angle of incidence of a light beam.

FIG. 26 shows the reflectivity of the optical waveguide shown in FIG. 24 as a function of the angle of incidence of the light.

FIG. 27 shows the construction of a fifth exemplary embodiment of an optical waveguide according to certain embodiments of the invention in the form of a diagram.

FIG. 28 shows the retardance of the optical waveguide shown in FIG. 27 as a function of the angle of incidence of a light beam.

FIG. 29 shows, for the example shown in FIG. 27, the transmittance for normal-incidence light as a function of the wavelength of the incident light.

FIG. 30 shows the construction of a sixth exemplary embodiment of an optical waveguide according to certain embodiments of the invention in the form of a diagram.

FIG. 31 shows the retardance of the optical waveguide shown in FIG. 30 as a function of the angle of incidence of a light beam.

FIG. 32 shows, for the example shown in FIG. 30, the transmittance for normal-incidence light as a function of the wavelength of the incident light.

FIG. 33 shows the basic construction of a partial region of an optical waveguide according to certain embodiments of the invention in accordance with the first to fourth exemplary embodiments in a sectional view.

FIG. 34 shows the basic construction of a partial region of an optical waveguide according to certain embodiments of the invention in accordance with the fifth and sixth exemplary embodiments in a sectional view.

FIG. 35 schematically shows a section through an optical waveguide according to certain embodiments of the invention in accordance with a seventh exemplary embodiment.

FIG. 36 schematically shows an image reproduction apparatus according to certain embodiments of the invention in the form of a block diagram.

FIG. 37 schematically shows an image capture apparatus according to certain embodiments of the invention in the form of a block diagram.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

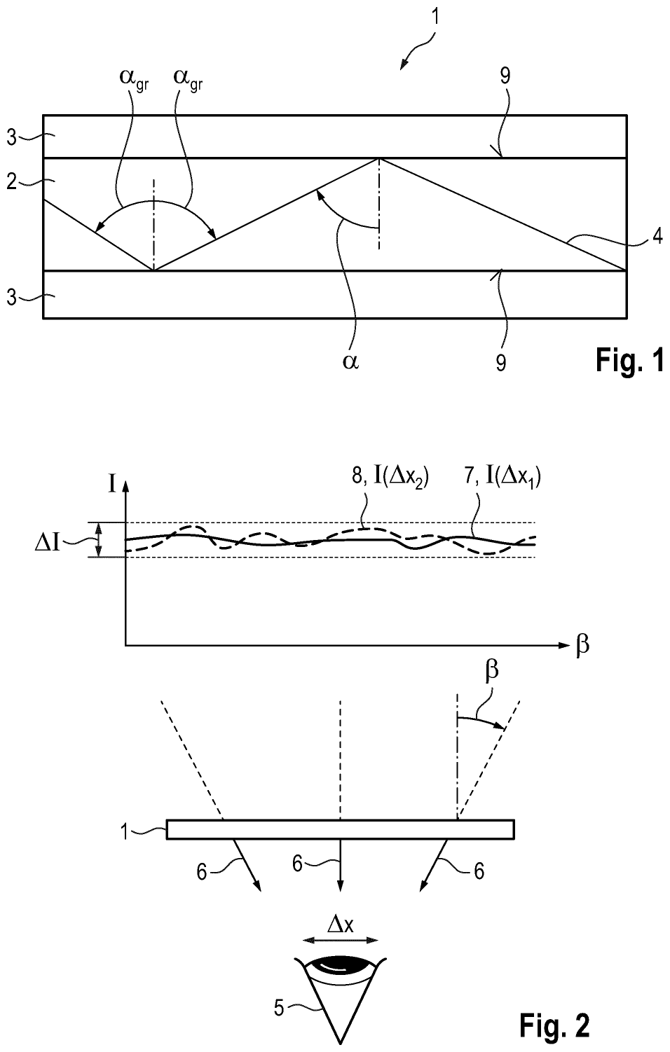

FIG. 1 schematically shows the propagation of a light beam in an optical waveguide 1, specifically in a light guide plate, by total internal reflection. The light guide plate 1 comprises a substrate 2 or a first element 2, having a refractive index n₁. The substrate or first element 2 is at least partially surrounded by a material 3 or a second element 3, having a refractive index no. The second element or material 3 surrounding the substrate or first element 2 can be air, for example. The refractive index of the substrate or first element 2 is greater than that of the second element 3 (n₁>n₀). Light 4 radiated into the substrate 2 is guided in the optical waveguide 1 by total internal reflection if the angle α of incidence of said light is between 90 degrees and the critical angle of total internal reflection α_{gr}. The total internal reflection takes place at the boundary surfaces 9 of the substrate 2.

FIG. 2 schematically shows the output coupling of light beams 6 from the optical waveguide 1. The output coupled light beams 6 have an output coupling angle β. An eyebox or an eye is identified by the reference numeral 5. The output coupled light beams 6 are ideally output coupled in the direction of the eye or the eyebox 5. The diagram shown at the top in FIG. 2 illustrates, for two different deviations of the position of the eye or for two different extents of the eyebox 5 in the x-direction Δx, the light intensity I as a function of the output coupling angle β as a diagram. In this case, the curve 7 denotes the intensity profile I(Δx₁) for a first position Δx₁ within the eyebox. The curve 8 shows the intensity profile I(Δx₂) for a second position Δx₂ within the eyebox. Overall, the output coupling should be homogeneous, i.e. A/should be small for different output coupling angles 8, but also for defined extents of the eyebox 5 or positional deviations of the eye 5 in the x-direction proceeding from an initial position.

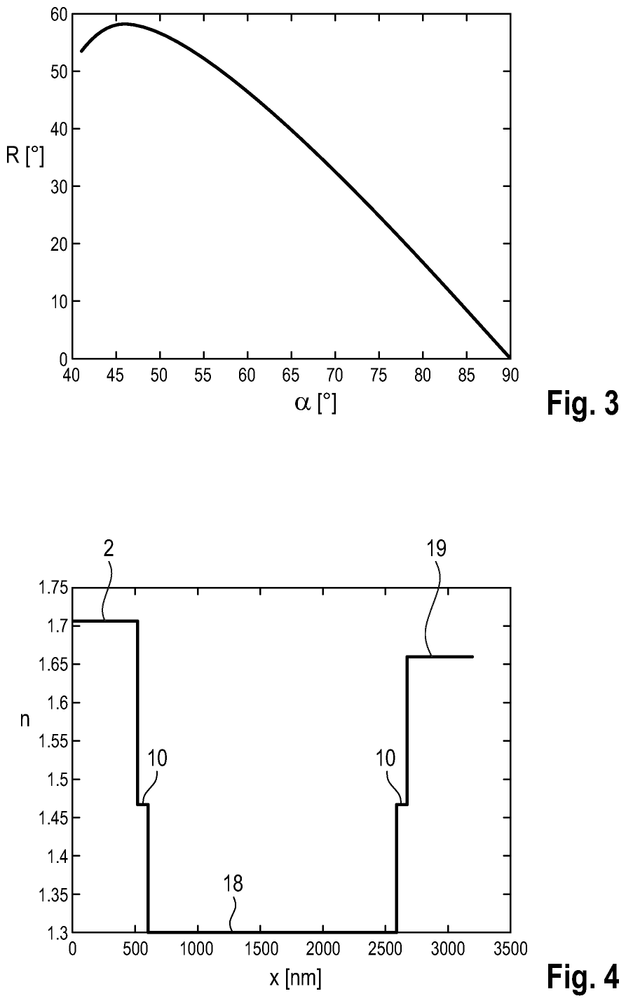

FIG. 3 shows the retardance R in degrees as a function of the angle α of incidence of a light beam on a boundary surface 9 during light propagation in the interior of an optical waveguide 1 having a refractive index n₁ of 1.7 and with the surroundings having a refractive index n₀ of 1.0. For the angular range of beam propagation of from 50 degrees to 90 degrees, this range being relevant to the light propagation within the optical waveguide, the outcome is retardations, i.e. a retardance of up to 58 degrees. As already explained in the introduction, this is undesirable in view of impending changes in the polarization state of the light 4 during the propagation thereof in the waveguide.

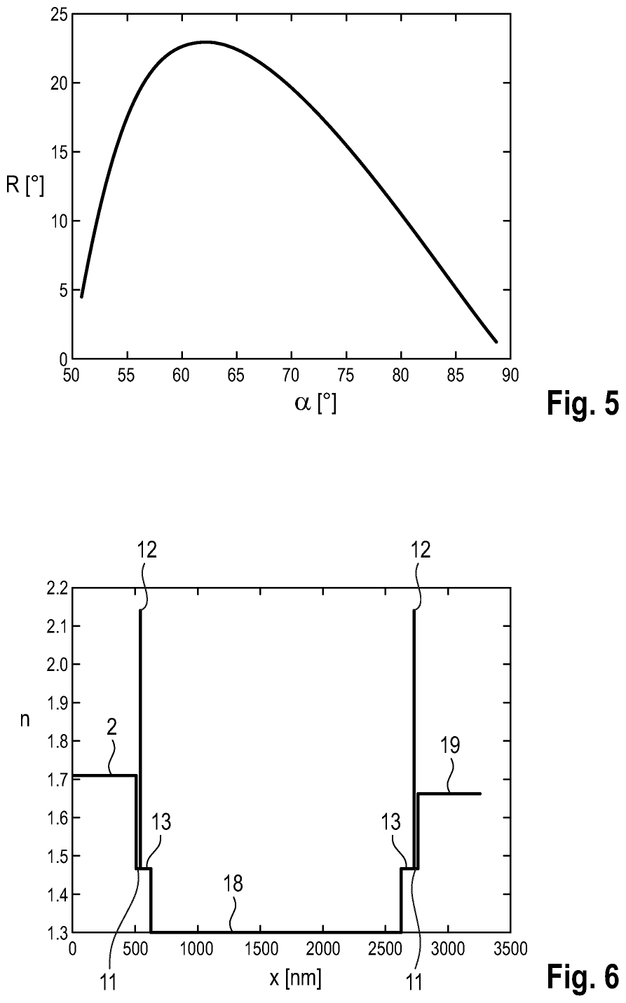

FIGS. 4 to 9 show various antireflection or antireflective coatings having refractive indices of between 1.7 and 1.3 and the retardance thereof. FIGS. 4, 6 and 8 each show on the x-axis the spatial coordinate x in nanometers (nm) in a direction perpendicular to the respective boundary surface 9 of the substrate 2 of the optical waveguide 1, said substrate being designed for guiding light. The y-axis shows the refractive index n. FIGS. 5, 7 and 9 each show the profile of the retardance R in degrees on the y-axis as a function of the angle α of incidence in degrees of the light 4 guided in the optical waveguide 1 on the x-axis.

In FIG. 4, from the substrate 2 only a range of from 0 nm to 500 nm in the x-direction is shown for illustrative reasons. It goes without saying that the substrate can be designed to be thicker (or thinner). In general, the substrate is significantly thicker than the coating or the adhesive layer. This also applies to all the subsequent figures showing a substrate having an exemplary layer thickness of 500 nm. The substrate 2 has a refractive index of somewhat more than 1.7. A layer ply 10 having a layer thickness of approximately 100 nm and a refractive index of somewhat more than 1.45 is arranged on the boundary surface 9 of the substrate 2. An adhesive or cement 15 having a layer thickness of approximately 2000 nm and a refractive index of 1.3 is arranged on said layer ply 10. Arranged on the adhesive 18 is a layer ply corresponding to the layer ply 10, and a further element 19, from which only a range up to 3200 nm in the x-direction is shown for illustrative reasons and which has a refractive index of approximately 1.65. FIG. 5 shows, for the arrangement shown in FIG. 4, the retardance R as a function of the angle α of incidence of the light guided in the optical waveguide. The maximum retardance is approximately 23 degrees.

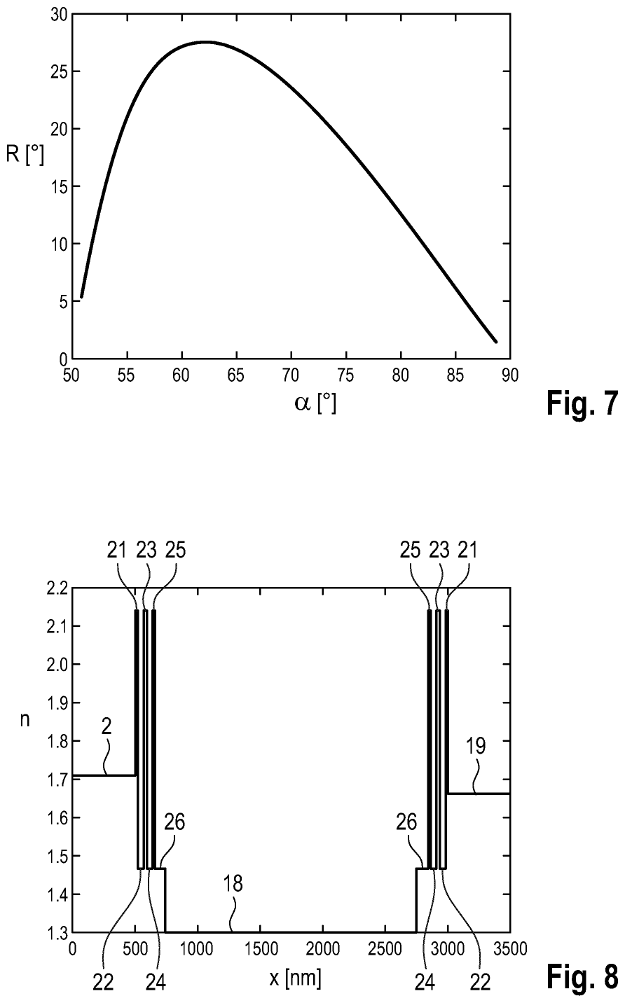

In FIG. 6, the substrate 2, as in FIG. 4, has a layer thickness of 500 nm and a refractive index of somewhat more than 1.7. A first thin layer 11 having a refractive index of approximately 1.45 is arranged on the boundary surface 9 of the substrate 2. A second thin layer 12 having a refractive index of somewhat more than 2.1 is arranged on the first layer 11. A third layer 13 having a layer thickness of approximately 100 nm and a refractive index of somewhat more than 1.45 is arranged on said second layer 12. An adhesive 18 having a layer thickness of approximately 2000 nm and a refractive index of 1.3 is arranged on said layer 13. Arranged on the adhesive 18 is a layer corresponding to the third layer 13 in regard to the refractive index, arranged on this layer is a layer corresponding to the second layer 12 in regard to the refractive index, arranged on this layer is a layer corresponding to the first layer 11 in regard to the refractive index, and arranged on this layer is a further element 19 having a refractive index of approximately 1.65. FIG. 7 shows, for the arrangement shown in FIG. 6, the retardance R as a function of the angle α of incidence of the light guided in the optical waveguide 1. The maximum retardance is approximately 28 degrees. This value is greater than the retardance shown in FIG. 5.

In FIG. 8, the substrate 2, as in FIG. 4, has a refractive index of somewhat more than 1.7. A first thin layer 21 having a refractive index of somewhat more than 2.1 is arranged on the boundary surface 9 of the substrate 2. A second layer 22 having a refractive index of somewhat more than 1.45 is arranged on said layer 21. A third layer 23 having a refractive index of somewhat more than 2.1 is arranged on said layer 22. A fourth layer 24 having a refractive index of somewhat more than 1.45 is arranged on said layer 23. A fifth layer 25 having a refractive index of somewhat more than 2.1 is arranged on said layer 24. A sixth layer 26 having a layer thickness of approximately 100 nm and a refractive index of somewhat more than 1.45 is arranged on said layer 25. An adhesive 18 having a layer thickness of approximately 2000 nm and a refractive index of 1.3 is arranged on said layer 26. Arranged on the adhesive 18 is a layer corresponding to the sixth layer 26 in regard to the refractive index, arranged on this layer is a layer corresponding to the fifth layer 25 in regard to the refractive index, arranged on this layer is a layer corresponding to the fourth layer 24 in regard to the refractive index, arranged on this layer is a layer corresponding to the third layer 23 in regard to the refractive index, arranged on this layer is a layer corresponding to the second layer 22 in regard to the refractive index, arranged on this layer is a layer corresponding to the first layer 21 in regard to the refractive index, and arranged on this layer is a further element 19 having a refractive index of approximately 1.65.

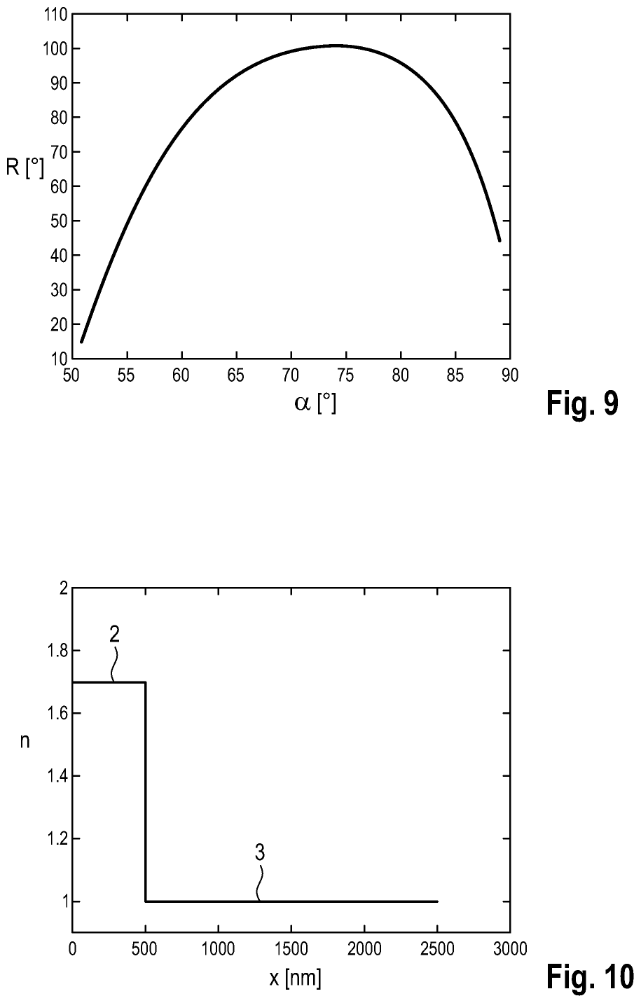

FIG. 9 shows, for the arrangement shown in FIG. 8, the retardance R as a function of the angle α of incidence of the light guided in the optical waveguide. The maximum retardance is approximately 100 degrees. It is evident from FIGS. 5, 7 and 9 that in the in FIGS. 4, 6 and 8, an increase in the number of layers and the higher average refractive index result in an increase in the retardance.

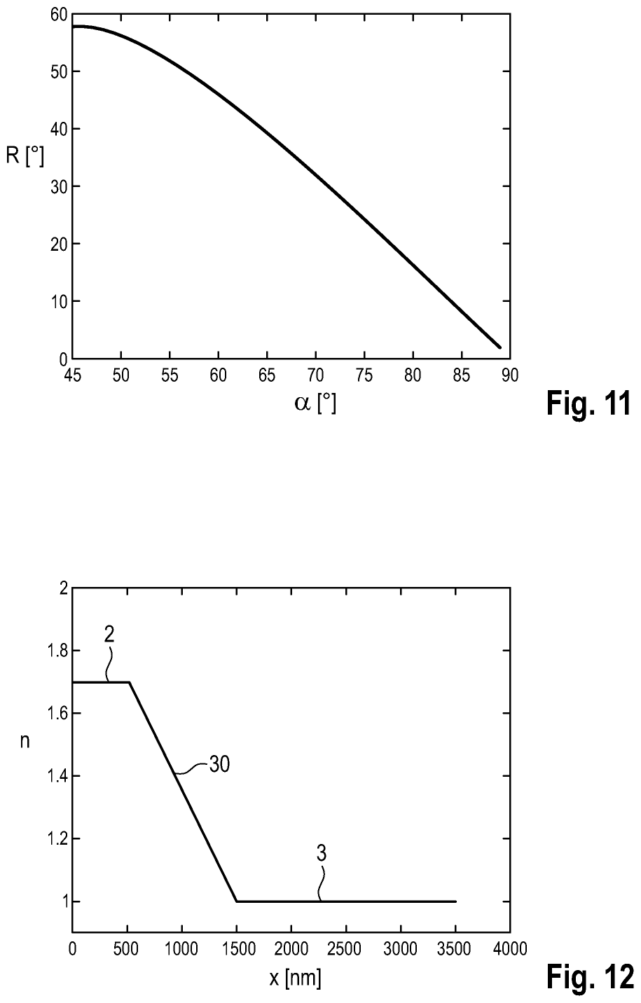

FIG. 10 shows a step transition of the refractive index n from a substrate 2 of an optical waveguide 1 having a refractive index of 1.7 and a layer thickness of 500 nm to surroundings 3 having a refractive index of 1.0 in the form of a diagram. The position of the spatial coordinate x perpendicular to one of the boundary surfaces 9 in nanometers is plotted on the x-axis. The refractive index n is plotted on the y-axis. FIG. 11 shows the retardance R in degrees of the optical waveguide shown in FIG. 10 as a function of the angle α of incidence in degrees of a light beam having a wavelength of 500 nm. The maximum retardance is 58 degrees.

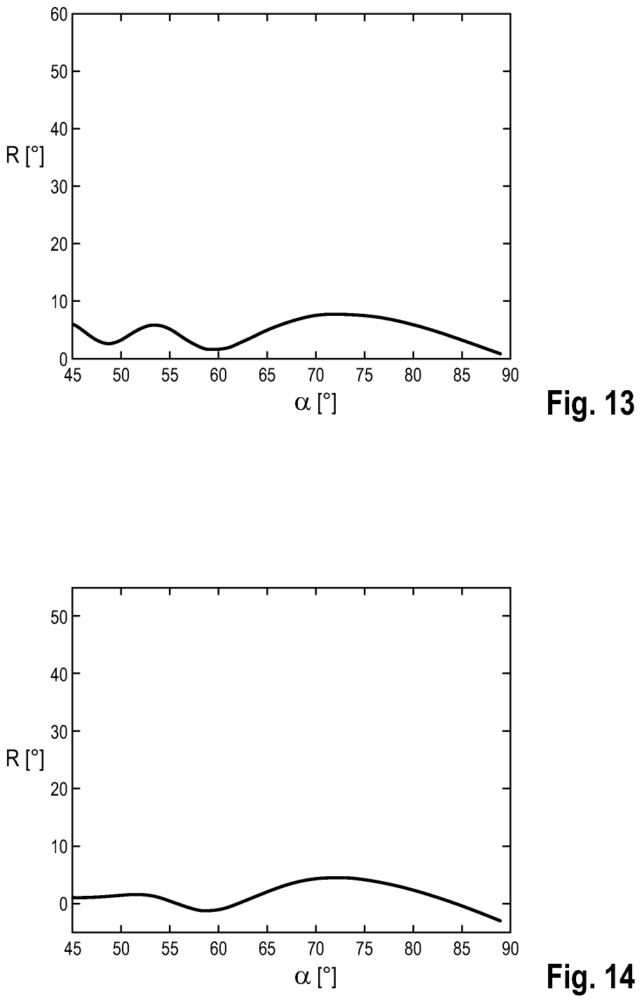

FIG. 12 shows the refractive index progression of a first exemplary embodiment of an optical waveguide 1 in the form of a diagram. The position x perpendicular to one of the boundary surfaces 9 in nanometers is plotted on the x-axis. The refractive index n is plotted on the y-axis. The substrate 2 of the optical waveguide 1 has a refractive index of 1.7. A coating 30 having a layer thickness of 1000 nm and a linear drop in the refractive index n from 1.7 to 1 over the course of 1 micrometer is arranged on the boundary surfaces 9 of the substrate 2. This coating 30 is outwardly bounded by air or some other material 3 having a refractive index of 1. FIG. 13 shows the retardance R of the optical waveguide 1 shown in FIG. 12 as a function of the angle α of incidence of a light beam having a wavelength of 500 nm. A linear refractive index progression over 1 micrometer accordingly leads to a maximum retardance of approximately 8 degrees at a wavelength of 500 nm. FIG. 14 shows the retardance R—averaged over all wavelengths from 400 nm to 700 nm—of the optical waveguide shown in FIG. 12 as a function of the angle α of incidence of a light beam. The averaged retardance is a maximum of 5 degrees.

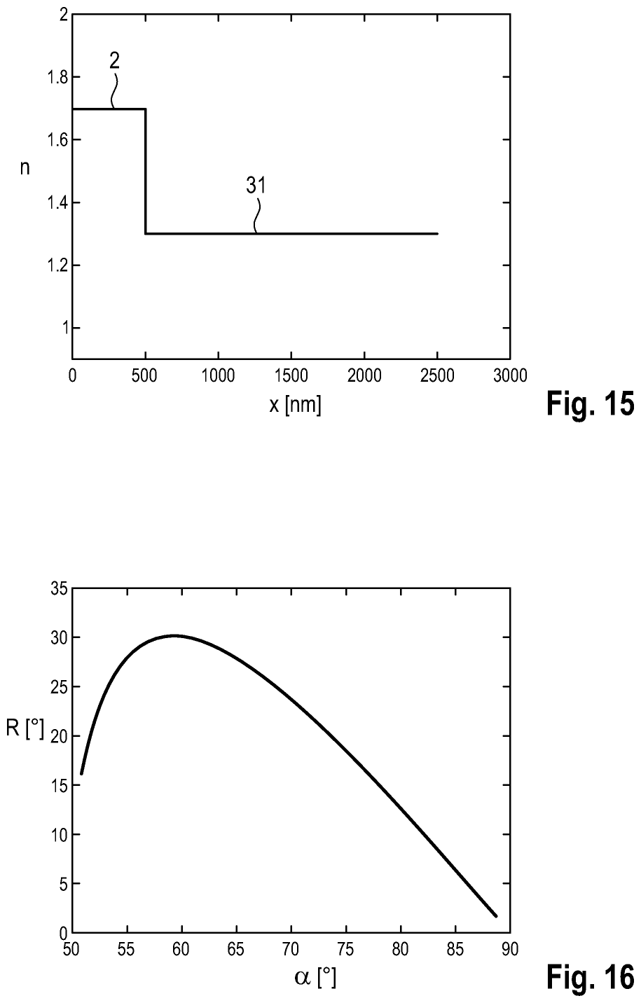

FIG. 15 shows a step transition of the refractive index n from a substrate 2 of an optical waveguide 1 having a refractive index of 1.7 and a layer thickness of 500 nm to a coating 31, for example a cement having a constant refractive index of 1.3 in the form of a diagram. The position of the spatial coordinate x perpendicular to one of the boundary surfaces 9 in nanometers is plotted on the x-axis. The refractive index n is plotted on the y-axis. FIG. 16 shows the retardance of the optical waveguide shown in FIG. 15 as a function of the angle of incidence of a light beam having a wavelength of 500 nm. The maximum retardance is 30 degrees.

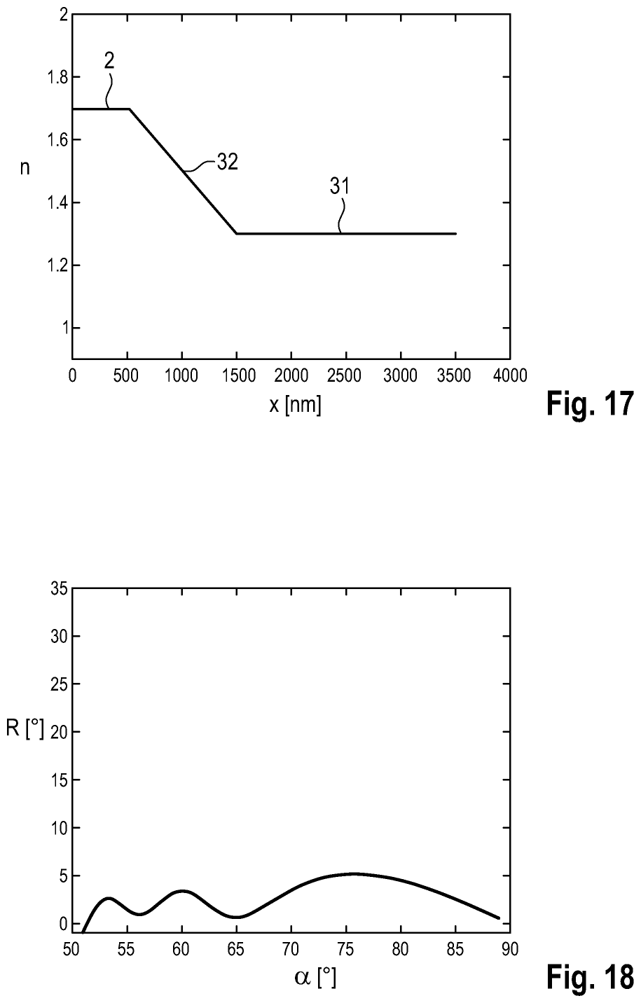

Instead of the stepped transition, a linear transition over a course or layer thickness of 1 micrometer leads to a retardance of approximately 6 degrees for light having a wavelength of 500 nm, as is evident from FIGS. 17 and 18. FIG. 17 shows the refractive index progression of a second exemplary embodiment of an optical waveguide 1 in the form of a diagram. The position of the spatial coordinate x perpendicular to one of the boundary surfaces 9 in nanometers is plotted on the x-axis. The refractive index n is plotted on the y-axis. The substrate 2 of the optical waveguide 1 has a layer thickness of 500 nm. A layer ply 32 having a layer thickness of 1000 nm and a linear drop in the refractive index n from 1.7 to 1.3 over the course of 1 micrometer is arranged on the boundary surfaces 9 of the substrate 2. This layer ply 32 is outwardly bounded by a further layer ply 31 having a refractive index of 1.3. FIG. 18 shows the retardance R of the optical waveguide shown in FIG. 17 as a function of the angle α of incidence of a light beam having a wavelength of 500 nm. A linear refractive index progression over 1 micrometer accordingly leads to a retardance of approximately 6 degrees at a wavelength of 500 nm.

For the minimum effect on the retardance, the linear refractive index progression must progress at least over a distance of 1 μm. Smaller values reduce the effect. Larger values, in contrast, may lead to difficulties in production.

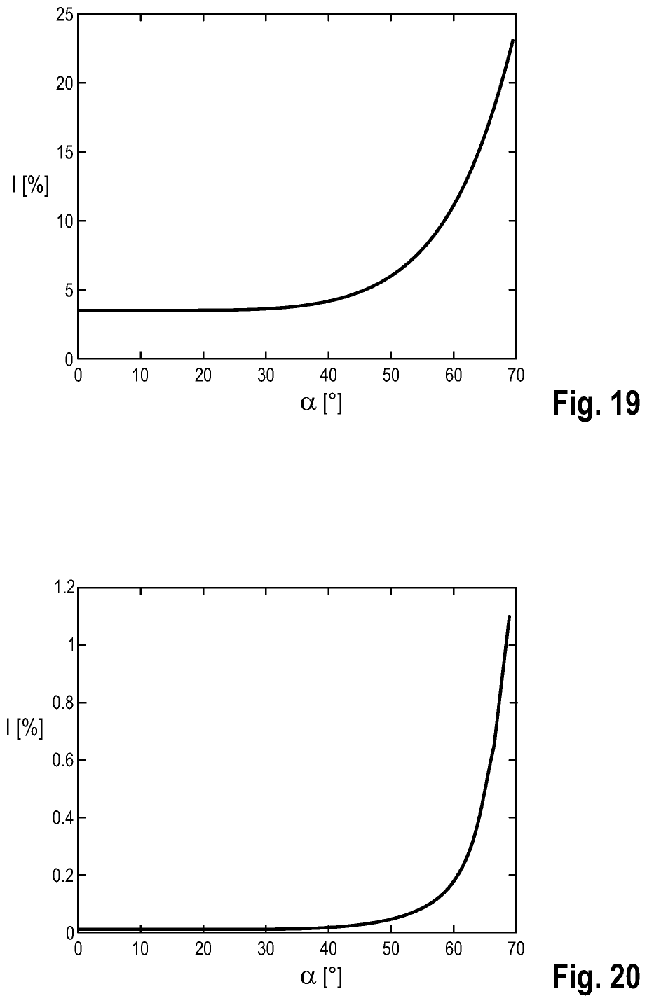

A gradient layer, i.e. a layer having a refractive index gradient, also reduces the external reflection quite considerably, as is shown below with reference to FIGS. 19 and 20. FIGS. 19 and 20 each show the reflectivity or reflectance in percent of the intensity/of the reflected light having a wavelength of 500 nm as a function of the angle α of incidence of the light in degrees-FIG. 19 for a configuration shown in FIG. 15, and FIG. 20 for a configuration shown in FIG. 17. While a configuration shown in FIG. 15 has, in accordance with FIG. 19, a reflectivity of between 4 percent at an angle of incidence of 0 degrees, i.e. with a straight see-through view, and 23 percent at an angle of incidence of almost 70 degrees, the reflectivity of a configuration shown in FIG. 17 is, in accordance with FIG. 20, only between 0 percent at an angle of incidence of 0 degrees, i.e. with a straight see-through view, and 1.1 percent at an angle of incidence of almost 70 degrees.

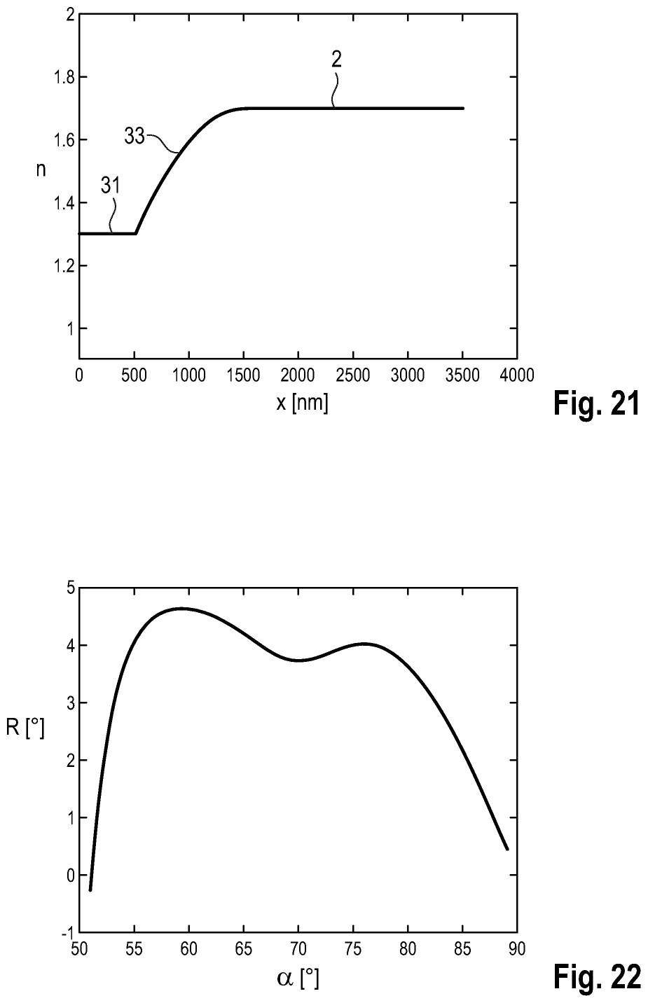

A linear refractive index progression as shown here is therefore a very good compromise between low retardance and low reflectivity during passage. A quadratic drop in the refractive index from the high refractive index to the low refractive index leads, as a quadratic approximation, to a lower retardance but a higher reflectivity for oblique angles. This is illustrated by FIGS. 21 to 23. By contrast, a quadratic rise from the low refractive index to the higher refractive index leads to a higher retardance but lower reflectivity during passage. This is illustrated by FIGS. 24 to 26.

FIG. 21 shows the refractive index as a function of the position in a direction perpendicular to the boundary surfaces of an optical waveguide 1 in accordance with a third exemplary embodiment of the present invention. The substrate 2 has a refractive index of 1.7. A coating having a first layer ply 33 with a quadratic drop in the refractive index from 1.7 to 1.3 over a course or layer thickness of 1 micrometer is arranged on the boundary surfaces 9. Arranged on this layer ply 33 having a refractive index gradient is a second substrate 31 having a refractive index of 1.3.

FIG. 22 shows the retardance of the optical waveguide shown in FIG. 21 as a function of the angle α of incidence of a light beam having a wavelength of 500 nm. A quadratically dropping refractive index progression over 1 micrometer accordingly leads to a maximum retardance of approximately 4.5 degrees at an angle of incidence of 60 degrees.

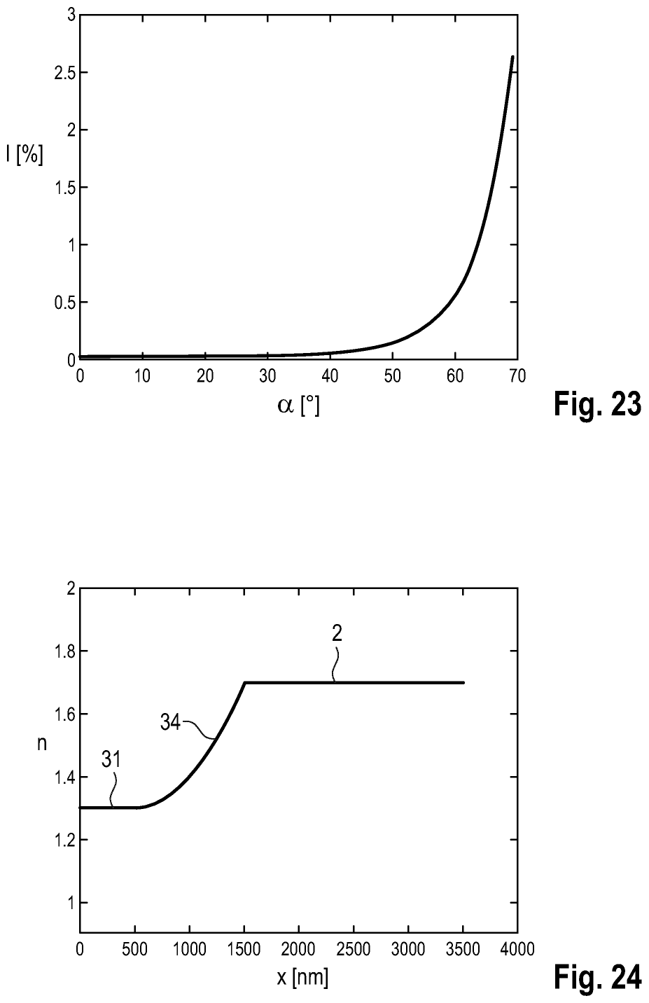

FIG. 23 shows, for the configuration shown in FIG. 21, the reflectance in percent of the intensity of the reflected light having a wavelength of 500 nm as a function of the angle α of incidence of the light in degrees. The reflectance is less than 0.1 percent at an angle of incidence of 0 degrees, i.e. with a straight see-through view, and is approximately 2.6 percent at an angle of incidence of almost 70 degrees.

FIG. 24 shows the refractive index as a function of the position or a spatial coordinate x in a direction perpendicular to the boundary surfaces 9 of an optical waveguide 1 in accordance with a fourth exemplary embodiment of the present invention. The substrate 2 has a refractive index of 1.7. Arranged on the boundary surfaces 9 of the substrate is a coating having a first layer ply 34, which has a layer thickness of 1 micrometer and a refractive index gradient from 1.7 to 1.3, and a further element 31 having a constant refractive index of 1.3. The refractive index of the first layer ply 34 rises from a boundary surface with respect to the further element 31 quadratically from 1.3 to 1.7 over a course or layer thickness of 1 micrometer to a boundary surface 9 with respect to the substrate 2.

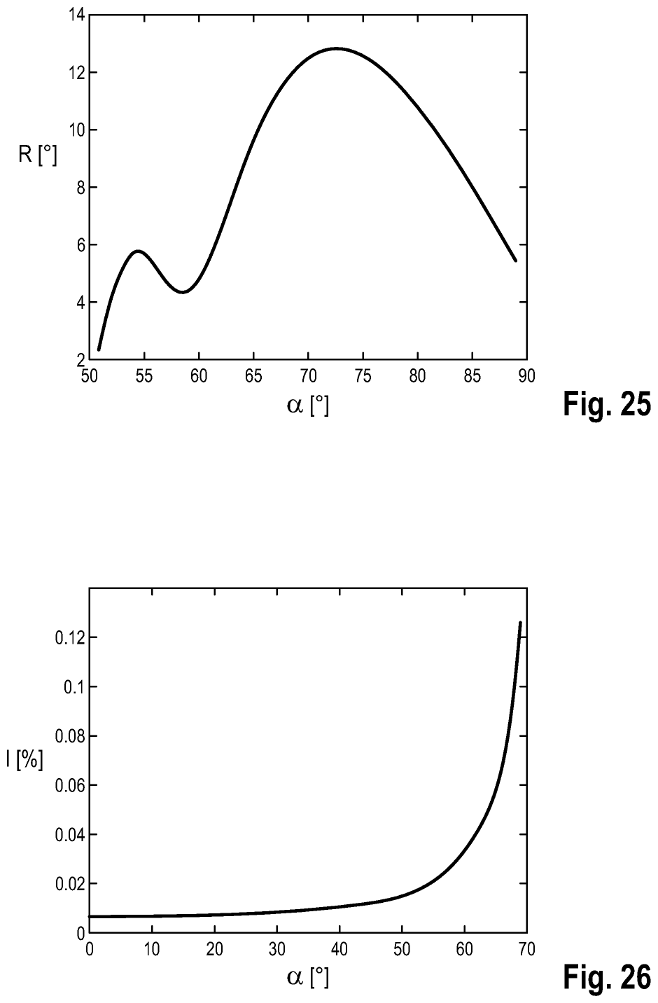

FIG. 25 shows the retardance R of the optical waveguide shown in FIG. 24 as a function of the angle α of incidence of a light beam having a wavelength of 500 nm. A quadratically rising refractive index progression over 1 micrometer accordingly leads to a maximum retardance of approximately 13 degrees at an angle of incidence of between 70 and 75 degrees.

FIG. 26 shows, for the configuration shown in FIG. 24, the reflectance in percent of the intensity/of the reflected light having a wavelength of 500 nm as a function of the angle α of incidence of the light in degrees. The reflectance is below 0.01 percent at an angle of incidence of 0 degrees, i.e. with a straight see-through view, and somewhat more than 0.12 percent at an angle of incidence of almost 70 degrees.

As an approximation to a refractive index distribution—described in the previous exemplary embodiments—in accordance with a continuous function as a function of the distance from the boundary surface 9 of the substrate 2, the refractive index gradient can be simulated by refractive index steps. The materials Al2O3, SiO2, MgF2 are suitable for this.

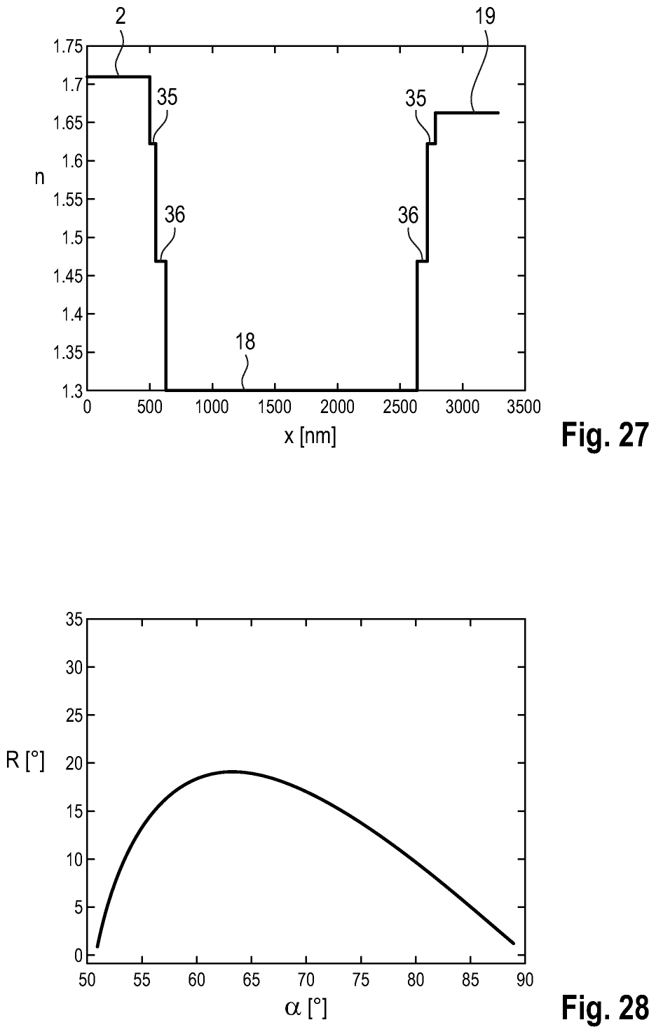

FIG. 27 shows the construction of a fifth exemplary embodiment of an optical waveguide in the form of a diagram. The diagram shows the refractive index n as a function of the position or location x in a direction perpendicular to the respective boundary surface 9 of the substrate 2. In the example shown, the substrate 2 has a layer thickness of 500 nm and a refractive index of somewhat more than 1.7. A coating comprising two layer plies is arranged on the boundary surface 9 of the substrate 2. The first layer ply 35, arranged directly on the boundary surface of the substrate, has a refractive index of 1.62 and a layer thickness of approximately 40 nm. A second layer ply 36 having a refractive index of 1.46 and a layer thickness of approximately 60 nm is arranged on the first layer ply 35. An adhesive 18 having a layer thickness of approximately 2000 nm and a refractive index of 1.3 is arranged thereon. Arranged on the adhesive 18 is a layer ply corresponding to the second layer ply 36 in regard to the refractive index, arranged on this layer ply is a layer ply corresponding to the first layer ply 35 in regard to the refractive index, and arranged on this layer ply is a further element 19 having a refractive index of approximately 1.65.

FIG. 28 shows the retardance R of the optical waveguide shown in FIG. 27 as a function of the angle α of incidence of a light beam having a wavelength of 500 nm. The maximum retardance of approximately 18 degrees occurs at an angle of incidence of between 60 and 65 degrees.

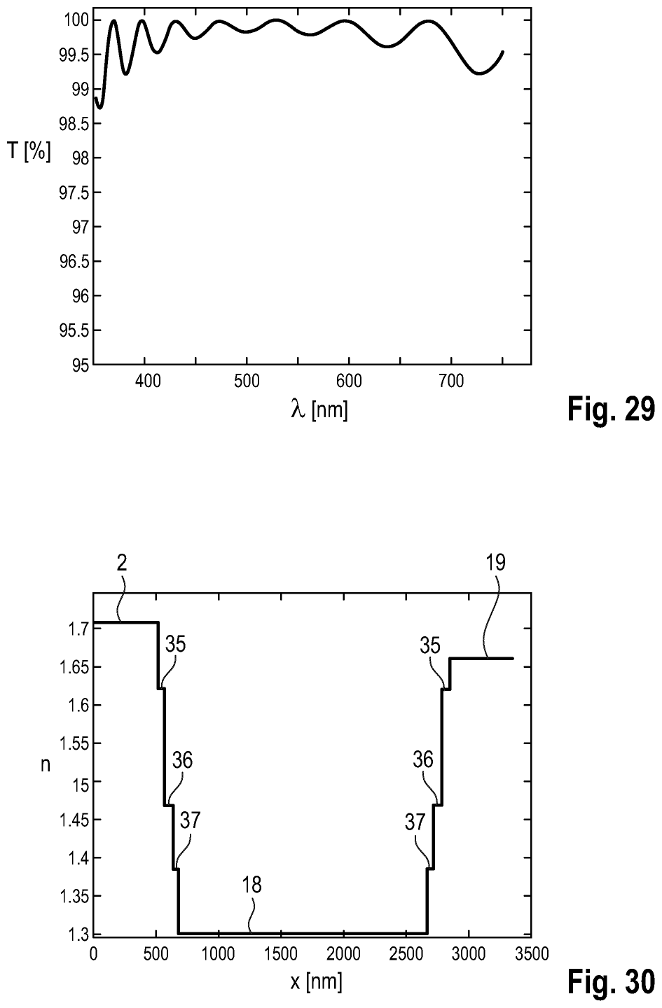

FIG. 29 shows, for the example shown in FIG. 27, the transmittance T in percent of the transmitted normal-incidence light as a function of the wavelength A of the incident light. The transmittance is above 99 percent in the range of visible light.

FIG. 30 shows the construction of a sixth exemplary embodiment of an optical waveguide in the form of a diagram. The diagram shows the refractive index n as a function of the position or location x in a direction perpendicular to the respective boundary surface 9 of the substrate 2. In the example shown, the substrate 2 has a refractive index of somewhat more than 1.7. A coating comprising three layer plies is arranged on the boundary surface 9 of the substrate 2. The first layer ply 35, arranged directly on the boundary surface 9 of the substrate 2, has a refractive index of 1.62 and a layer thickness of approximately 50 nm. A second layer ply 36 having a refractive index of 1.46 and a layer thickness of approximately 50 nm is arranged on the first layer ply 35. A third layer ply 37 having a refractive index of 1.37 and a layer thickness of approximately 50 nm is arranged on the second layer ply 36. An adhesive 18 having a layer thickness of approximately 2000 nm and a refractive index of 1.3 is arranged on this coating of the substrate 2. Arranged on the adhesive 18 is a layer corresponding to the third layer ply 37 in regard to the refractive index, arranged on this layer is a layer corresponding to the second layer ply 36 in regard to the refractive index, arranged on this layer is a layer corresponding to the first layer ply 35 in regard to the refractive index, and arranged on this layer is a further element 19 having a refractive index of approximately 1.65.

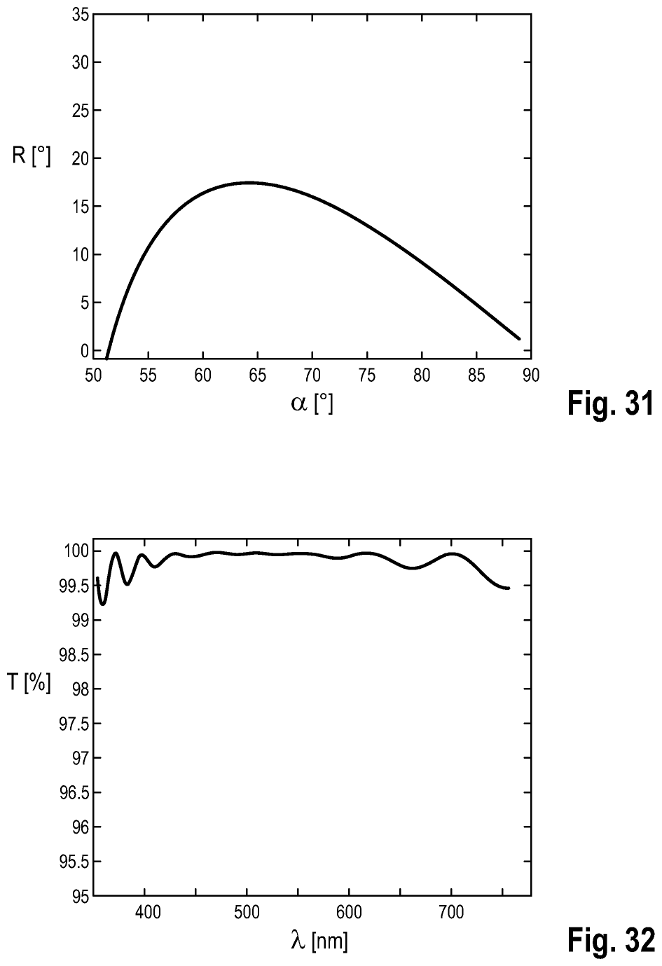

FIG. 31 shows the retardance R of the optical waveguide shown in FIG. 30 as a function of the angle α of incidence of a light beam having a wavelength of 500 nm. The maximum retardance of approximately 17 degrees occurs at an angle of incidence of between 60 and 65 degrees.

FIG. 32 shows, for the example shown in FIG. 29, the transmittance Tin percent of the transmitted normal-incidence light as a function of the wavelength A of the incident light. The transmittance is above 99.5 percent in the range of visible light.

In the fifth and sixth exemplary embodiments, the retardance is significantly improved by comparison with a coating having high index plies, i.e. plies having a refractive index which is greater than that of the substrate, as shown in FIGS. 6 and 8.

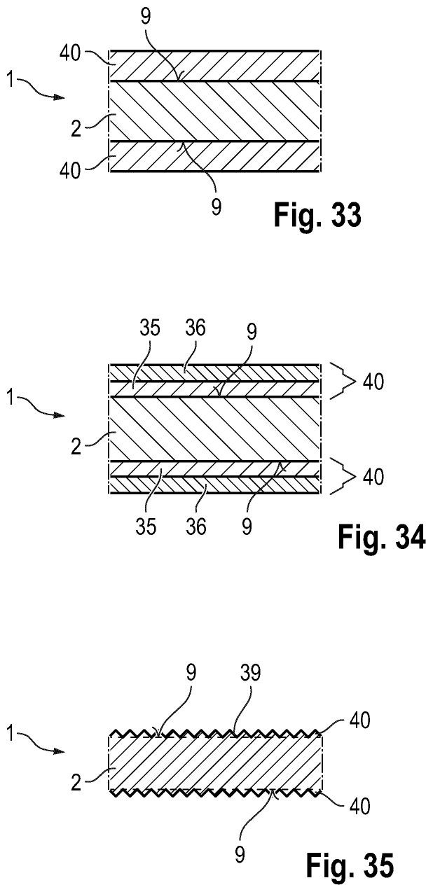

FIG. 33 schematically shows the basic construction of a partial region of an optical waveguide 1 in accordance with the first to fourth exemplary embodiments in a sectional view. In the first to fourth exemplary embodiments, the boundary surfaces 9 of the substrate 2 each have an outer layer 40 embodied as a coating having a refractive index progression in which the effective refractive index of the outer layer decreases over a course of 1 micrometer outward with increasing distance from the boundary surface. The outer layer 40 comprises at least one of the above-described layer plies 30, 32, 33 or 34.

FIG. 34 schematically shows the basic construction of a partial region of an optical waveguide 1 in accordance with the fifth and sixth exemplary embodiments in a sectional view. In the fifth and sixth exemplary embodiments, the boundary surfaces 9 of the substrate 2 each have an outer layer 40 embodied as a coating comprising a plurality of layer plies, e.g. two layer plies 35, 36 or three layer plies 35, 36, 37. In this case, the refractive index of a respective layer ply at a larger distance from the boundary surface 9 is lower than the refractive index of a layer ply at a smaller distance from the boundary surface 9.

A seventh exemplary embodiment of the present invention is explained in greater detail below with reference to FIG. 35. FIG. 35 schematically shows a section through a partial region of an optical waveguide 1. An outer layer 40 formed as a nanostructured surface region is arranged on the boundary surfaces 9 of the substrate 2. The surface of the substrate material, in the region of the outer layer 40, thus has depressions 39, for example pyramidal or conical depressions, which are at a distance of a maximum of 100 nm and have a depth of at least 300 nm, preferably of at least double the wavelength of the guided light, e.g. between 800 nm and 1600 nm. The individual elements of the nanostructuring of that surface of the optical waveguide 1 which forms the outer layer 40 are fashioned so as to produce approximately a linear refractive index progression in the effective refractive index.

For the antireflective effect in respect of optical waveguides, e.g. light guide plates, in the context of the present invention an outer layer approximated to a monotonic refractive index progression is thus used rather than standard antireflection layers. This outer layer simultaneously reduces the retardance for the light guided in the optical waveguide, for example in the form of a light guide plate. A linear progression of the refractive index is particularly advantageous in this case.

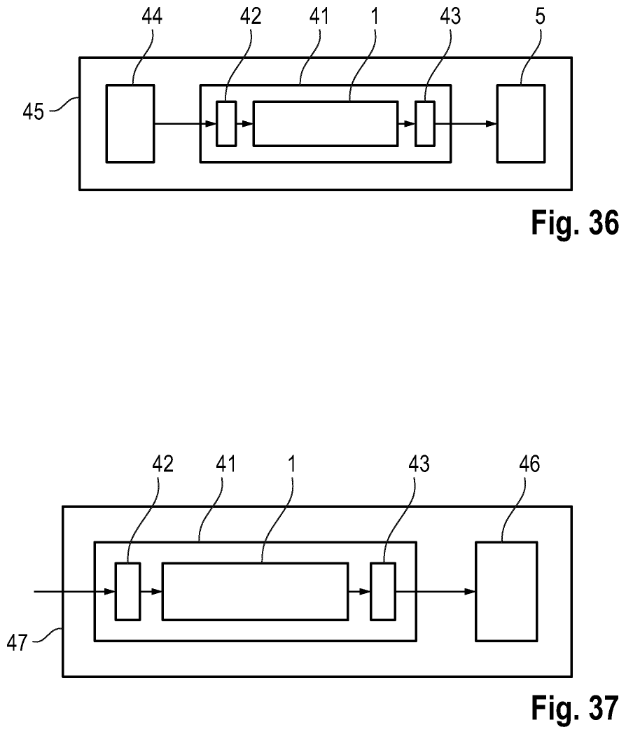

FIG. 36 schematically shows an image reproduction apparatus. The image reproduction apparatus 45 comprises an optical arrangement 41. The optical arrangement 41 comprises an optical waveguide 1 and also, coupled thereto, a device 42 for input coupling of light waves into the optical waveguide 1 and a device 43 for output coupling of light waves from the optical waveguide 1. The image reproduction apparatus 45 additionally comprises a picture generator 44 designed to input couple light waves via the device 42 for input coupling of light waves into the optical waveguide 1. Light waves are output coupled in the direction of an eyebox 5 by means of the device 43.

FIG. 37 schematically shows an image capture apparatus 47. The image capture apparatus 47 comprises a camera 46 and an above-described optical arrangement 41. Light waves from the surroundings are input coupled into the optical waveguide 1 by means of the device 42 for input coupling of light waves and are output coupled from said waveguide in the direction of the camera 46 by means of the device 43.

### LIST OF REFERENCE SIGNS

1 optical waveguide
2 substrate, first element
3 surrounding material, second element, air
4 light beam
5 eye, eyebox
6 light beam
7 intensity profile
8 intensity profile
9 boundary surface
10 layer ply
11 first thin layer
12 second thin layer
13 third layer
18 adhesive, cement
19 element
21 first thin layer
22 second layer
23 third layer
24 fourth layer
25 fifth layer
26 sixth layer
30 coating, layer ply
31 element
32 coating, layer ply
33 coating, layer ply
34 coating, layer ply
35 coating, layer ply
36 coating, layer ply
37 coating, layer ply
39 depressions
40 outer layer
41 optical arrangement
42 device for input coupling of light waves
43 device for output coupling of light waves
44 picture generator
45 image reproduction apparatus
46 camera
47 image capture apparatus
I light intensity
n refractive index
R retardance
T transmittance
X spatial coordinate perpendicular to the boundary surface
α angle of incidence
α_{gr} critical angle of total internal reflection
β output coupling angle
λ wavelength

1-14. (canceled)

15. An optical waveguide for arranging in a beam path of an optical arrangement, the optical waveguide comprising:
a substrate comprising at least two mutually opposite boundary surfaces for guiding light waves via total internal reflection,
wherein the at least two mutually opposite boundary surfaces each comprise an outer layer having a refractive index progression in which, proceeding from the respective boundary surface, the effective refractive index of the outer layer decreases over a defined course outward with increasing distance from the boundary surface.

16. The optical waveguide of claim 15, wherein the outer layer is a nanostructured surface region and/or a coating.

17. The optical waveguide of claim 15, wherein, proceeding from the respective boundary surface, the refractive index of the outer layer decreases outward at least partly in a continuous manner.

18. The optical waveguide of claim 15, wherein, proceeding from the respective boundary surface, the refractive index of the outer layer decreases outward at least partly in a stepped manner.

19. The optical waveguide of claim 18, wherein, proceeding from the respective boundary surface, the refractive index of the outer layer decreases outward at least partly in accordance with a linear or quadratic function of the distance from the respective boundary surface.

20. The optical waveguide of claim 15, wherein, proceeding from the respective boundary surface, the refractive index of the outer layer decreases outward at least partly in accordance with a function of the distance from the respective boundary surface.

21. The optical waveguide of claim 20, wherein, proceeding from the respective boundary surface, the refractive index of the outer layer decreases outward at least partly in accordance with a monotonic function of the distance from the respective boundary surface.

22. The optical waveguide of claim 15, wherein the outer layer comprises a coating having a thickness of at least 0.5 micrometers and/or the outer layer comprises a nanostructured surface region comprising depressions in the surface having a depth of at least 300 nanometers and/or a distance from one another of a maximum of 100 nanometers.

23. The optical waveguide of claim 15, wherein the outer layer comprises a coating, the refractive index of the coating decreasing by at least 0.4 over a layer thickness of at least 0.7 micrometers and/or a layer thickness of at least 1.3 micrometers.

24. The optical waveguide of claim 15, wherein the outer layer comprises a coating comprising a plurality of layer plies which are arranged one on top of another and the refractive indices of which differ from one another.

25. The optical waveguide of claim 15, wherein the outer layer comprises a coating containing aluminum oxide (Al2O3) and/or silicon oxide (SiO2) and/or magnesium fluoride (MgF2).

26. An optical arrangement, comprising:
the optical waveguide of claim 15; and
a device for output coupling and/or input coupling an imaging beam path into the optical waveguide.

27. An image reproduction apparatus, comprising the optical arrangement of claim 26.

28. An image capture apparatus, comprising the optical arrangement of claim 26.
